(19) United States
(12) Patent Application Publication
(10) Pub. No.: US 2012/0114184 A1
(43) Pub. Date: May 10, 2012

(54) TRAJECTORY-BASED METHOD TO DETECT AND ENHANCE A MOVING OBJECT IN A VIDEO SEQUENCE

(75) Inventors: Jesus Barcons-Palau, Plainsboro, NJ (US); Sitaram Bhagavathy, Plainsboro, NJ (US); Joan Llach, Princeton, NJ (US); Dong-Qing Zhang, Plainsboro, NJ (US)

(73) Assignee: THOMSON LICENSING, Issy-Les Moulineaux (FR)

(21) Appl. No.: 13/386,145

(22) PCT Filed: Jul. 20, 2010
(86) PCT No.: PCT/US2010/002039

§ 371 Date: Jan. 20, 2012

Related U.S. Application Data
(60) Provisional application No. 61/271,396, filed on Jul. 21, 2009.

(51) Int. Cl. G06K 9/68

(52) U.S. Cl. 382/107

(57) ABSTRACT

The present invention concerns a method and associated apparatus for using a trajectory-based technique to detect a moving object in a video sequence, such as the ball in a soccer game. In one embodiment, the method comprises steps of identifying and evaluating sets of connected components in a video frame, filtering the list of connected components by comparing features of the connected components to predetermined criteria, identifying candidate trajectories across multiple frames, evaluating the candidate trajectories to determine a selected trajectory, and processing images in the video sequence based at least in part upon the selected trajectory.

### CROSS REFERENCE TO RELATED APPLICATION

This application claims priority to and all benefits accruing from provisional application filed in the United States Patent and Trademark Office on Jul. 21, 2009 and assigned Ser. No. 61/271,396.

### BACKGROUND OF THE INVENTION

The present invention generally relates to a method and associated apparatus for using a trajectory-based technique to detect a moving object in a video sequence, such as the ball in a soccer game. In one embodiment, the method comprises steps of identifying and evaluating sets of connected components in a video frame, filtering the list of connected components by comparing features of the connected components to predetermined criteria, identifying candidate trajectories across multiple frames, evaluating the candidate trajectories to determine a selected trajectory, and processing images in the video sequence based at least in part upon the selected trajectory.

This section is intended to introduce the reader to various aspects of art, which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

As mobile devices have become more capable and mobile digital television standards have developed, it has become increasingly practical to view video programming on such devices. The small screens of these devices, however, present some limitations, particularly for the viewing of sporting events. Small objects, such as the ball in a sports program, can be difficult to see. The use of high video compression ratios can exacerbate the situation by significantly degrading the appearance of small objects like a ball, particularly in a far-view scene.

It can therefore be desirable to apply image processing to enhance the appearance of the ball. However, detecting the ball in sports videos is a challenging problem. For instance, the ball can be occluded or merged with field lines. Even when it is completely visible, its properties, such as shape, area, and color, may vary from frame to frame. Furthermore, if there are many objects with ball-like properties in a frame, it is difficult to make a decisions as to which is the ball based upon only one frame, and thus difficult to perform image enhancement. The invention described herein addresses these and/or other problems.

### SUMMARY OF THE INVENTION

In order to solve the problems described above, the present invention concerns a method and associated apparatus for using a trajectory-based technique to detect a moving object in a video sequence, such as the ball in a soccer game. In one embodiment, the method comprises steps of identifying and evaluating sets of connected components in a video frame, filtering the list of connected components by comparing features of the connected components to predetermined criteria, identifying candidate trajectories across multiple frames, evaluating the candidate trajectories to determine a selected trajectory, and processing images in the video sequence based at least in part upon the selected trajectory. This and other aspects of the invention will be described in detail with reference to the accompanying drawings.

### BRIEF DESCRIPTION OF THE DRAWINGS

The above-mentioned and other features and advantages of this invention, and the manner of attaining them, will become more apparent, and the invention will be better understood, by reference to the following description of embodiments of the invention taken in conjunction with the accompanying drawings, wherein:

FIG. 1 is a flowchart of a trajectory-based ball detection method;

FIG. 2 is an illustration of the processes of generating a playfield mask and identifying ball candidates;

FIG. 3 is an illustration of ball candidates in a video frame;

FIG. 4 is a plot of example candidate trajectories; and

FIG. 5 is a plot of example candidate trajectories with a trajectory selected as the ball trajectory.

The exemplifications set out herein illustrate preferred embodiments of the invention, and such exemplifications are not to be construed as limiting the scope of the invention in any manner.

### DESCRIPTION OF THE PREFERRED EMBODIMENTS

As described herein, the present invention provides a method and associated apparatus for using a trajectory-based technique to detect a moving object in a video sequence, such as the ball in a soccer game. In one embodiment, the method comprises steps of identifying and evaluating sets of connected components in a video frame, filtering the list of connected components by comparing features of the connected components to predetermined criteria, identifying candidate trajectories across multiple frames, evaluating the candidate trajectories to determine a selected trajectory, and processing images in the video sequence based at least in part upon the selected trajectory.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

The present invention may be implemented in signal processing hardware or software within a television production or transmission environment. The method may be performed off-line or in real-time through the use of a look-ahead window.

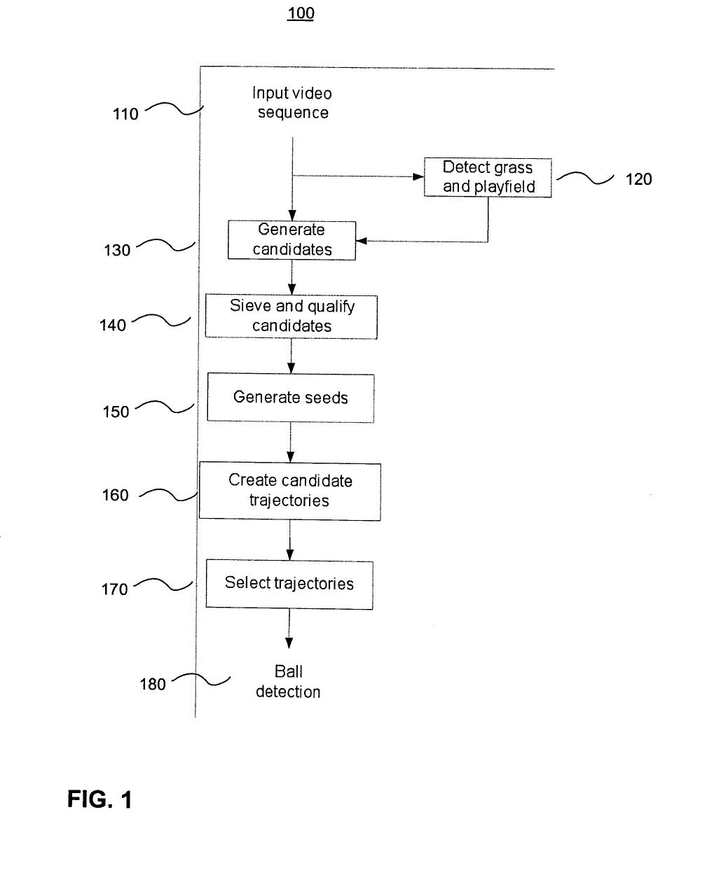

FIG. 1 is a flowchart of one embodiment of a trajectory-based ball detection method 100. The method may be applied to an input video sequence 110, which may be a sporting even such as a soccer game.

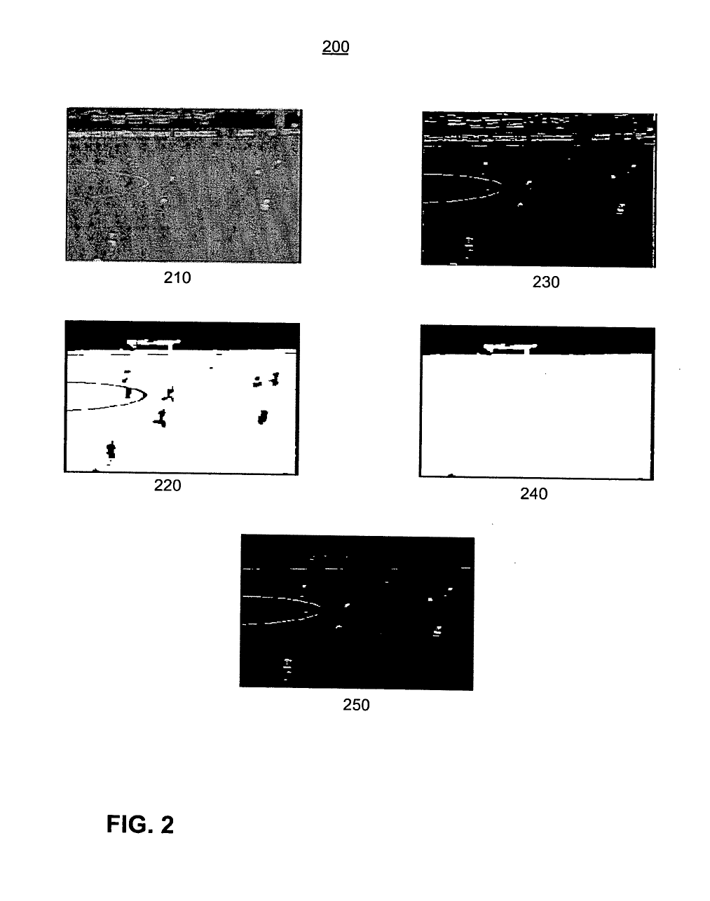

At step 120, input frames from the video sequence 110 are processed into binary field masks. The mask generation process comprises detecting the grass regions to generate a grass mask GM and then computing the playfield mask, PM, which is the solid area covering these grass regions. In a simple case, the pixels representing the playing field are identified using the knowledge that the field is generally covered in grass or grass-colored material. The result is a binary mask classifying all field pixels with a value of 1 and all non-field pixels, including objects in the field, with a value of 0. Various image processing techniques may then be used to then identify the boundaries of the playing field and create a solid field mask. For instance, all pixels within a simple bounding box encompassing all of the contiguous regions of field pixels above a certain area threshold may be included in the field mask. Other techniques, including the use of filters, may also be used to identify the field and eliminate foreground objects from the field mask. The mask generation process is further described below with respect to FIG. 2. While grass is used in this exemplary embodiment, the present invention is not restricted to grass playing surfaces as any background playing surface can be used with this technique, such as ice, gym floors or the like.

At step 130, an initial set of candidate objects that may be the ball are identified. First, local luminance maxima in the video frame are detected by convolving the luminance component Y of the frame F with a normalized Gaussian kernel Gₙₖ, generating the output image Y_{conv}. A pixel (x,y) is designated as a local maximum if Y(x,y)>Y_{conv}(x,y)+Tₗₘₐₓ, where Tₗₘₐₓ is a preset threshold. This approach generally isolates pixels representing the ball, but also isolates parts of the players, field lines, goalmouths, and other features, since these features also contain bright spots. In a preferred embodiment, Gₙₖ is a 9×9 Gaussian kernel with variance 4 and the threshold Tₗₘₐₓ is 0.1.

The result of the luminance maxima detection process is a binary image Iₗₘ with 1's denoting bright spots. Various clusters of pixels, or connected components, will appear in the image Jₗₘ. The set of connected components in Iₗₘ, Z={Z₁, Z₂, . . . , Zₙ}, are termed “candidates,” one of which is likely to represent the ball. Information from the playfield detection of step 120 may be used at step 130, or at step 140 described below, to reduce the number of candidates. In far-view scenes, the assumption can be made that the ball will be inside the playfield, and that objects outside the playfield may be ignored. The candidate generation process is also further described below with respect to FIG. 2.

At step 140, those candidates from step 130 that are unlikely to be the ball are eliminated using a sieving and qualification process. To determine which candidates should be discarded, a score is computed for each candidate, providing a quantification of how similar each candidate is to a pre-established model of the ball. In a preferred embodiment, three features of the ball are considered:
Area (A), is the number of pixels in a candidate Z.
Eccentricity (E), is a measure of “elongatedness”. The more elongated an object is, the higher the eccentricity. In a preferred embodiment, binary image moments are used to compute the eccentricity.
Whiteness (W), is a measure of how close the color of a pixel is to white. In a preferred embodiment, given the r, g and b (red, green and blue components respectively) of a given pixel, whiteness is defined as:

$$W = \sqrt{{( \frac{3 r}{r + g + b} - 1 )}^{2} + {( \frac{3 b}{r + g + b} - 1 )}^{2}}$$

Analysis of sample video has shown that both area and whiteness histograms follow a Gaussian distribution. The eccentricity histogram also follows a Gaussian distribution after a symmetrization to account for the minimum value of eccentricity being 1. Candidates can be rejected if their feature values lie outside the range μ±nσ, where μ is the mean and σ is the standard deviation of the corresponding feature distribution. Based on this sieving process, candidates in Z can be accepted as ball-like or rejected. A loose range is used because the features of the ball could vary significantly from frame to frame. Colors other than white, and subsequently the “whiteness” component used in this exemplary embodiment can be substituted with the appropriate color of any device, such as orange for a basketball, brown for a football, or black for a puck.

In a preferred embodiment, A is modeled as a Gaussian distribution with μ_{A}=7.416 and σ_{A}=2.7443, and the range is controlled by n_{A}=3. E is modeled as a Gaussian distribution with μ_{E}=1 and σ_{E}=1.2355, and the range is controlled by n_{E}=3. W is modeled as a Gaussian distribution with μ_{w}=0.14337 and σ_{w}=0.034274, and the range is controlled by n_{w}=3. Candidates must meet all three criteria to be kept. The sieving process may be repeated with tighter values of n to produce smaller numbers of candidates.

Also in step 140, the candidates C that pass the initial sieving process are further qualified based upon factors including:
Distance to the closest candidate (DCC), the closest distance in pixels between any of the pixels in a candidate Cᵢ with all the other pixels in the other candidates {C-Cᵢ},
Distance to the edge of the field (DF), the closest distance in pixels between the center of a given candidate and the perimeter of the playfield mask PM, and
Number of candidates inside the respective blob in the object mask (NCOM), the number of candidates in C lying inside the same connected component in the object mask OM as a given candidate Cᵢ. OM, the object mask, is a binary mask indicating the non-grass pixels inside the playfield and is defined as the inversion of GM inside PM.

In a preferred embodiment, the ball is expected to be an isolated object inside the playfield most of the time, in contrast to objects like the socks of players, which are always close to each other. Hence, candidates without a close neighbor, and with a high value of DCC, are more likely to be the ball. Likewise, the ball is also not expected to be near the boundaries of the field. This assumption is especially important if there are other spare balls inside the grass but outside the bounding lines of the playfield.

The object mask OM provides information about which pixels inside the playfield are not grass. This includes players and field lines, which may contain “ball-like” blobs inside them (e.g., socks of players or line fragments). Ideally, ball candidates should not lie inside other larger blobs. As we expect only one candidate C₁ inside a connected component of the OM, NCOMᵢ is expected to be 1 in our ideal model.

A score Sᵢ for a candidate Cᵢ is computed as:

$${S}_{i} = {S}_{A , i} + {S}_{E , i} + {S}_{W , i}$$

$$\text{where:}$$

$${S}_{A , i} = \{ \begin{matrix}1 & if {μ}_{A} - {n}_{A} {μ}_{A} < {A}_{i} < {μ}_{A} + {n}_{A} {μ}_{A} \\ 0 & otherwise\end{matrix} \\ {S}_{E , i} = \{ \begin{matrix}1 & if {μ}_{E} - {n}_{E} {μ}_{E} < {E}_{i} < {μ}_{E} + {n}_{E} {μ}_{E} \\ 0 & otherwise\end{matrix} \\ {S}_{W , i} = \{ \begin{matrix}1 & if {μ}_{W} - {n}_{W} {μ}_{W} < {W}_{i} < {μ}_{W} + {n}_{W} {μ}_{W} \\ 0 & otherwise\end{matrix}$$

At this point, candidates having a score equal to 0 are rejected. For the remaining candidates, the score Sᵢ is penalized using the other features as follow:

$${S}_{i} = \{ \begin{matrix}{S}_{i} & if {DCC}_{i} \leq {DCC}_{thr} \\ 1 & otherwise\end{matrix} \\ {S}_{i} = \{ \begin{matrix}{S}_{i} & if {DF}_{i} \leq {DF}_{thr} \\ 1 & otherwise\end{matrix} \\ {S}_{i} = \{ \begin{matrix}{S}_{i} & if {NCOM}_{i} > {NCOM}_{thr} \\ 1 & otherwise\end{matrix}$$

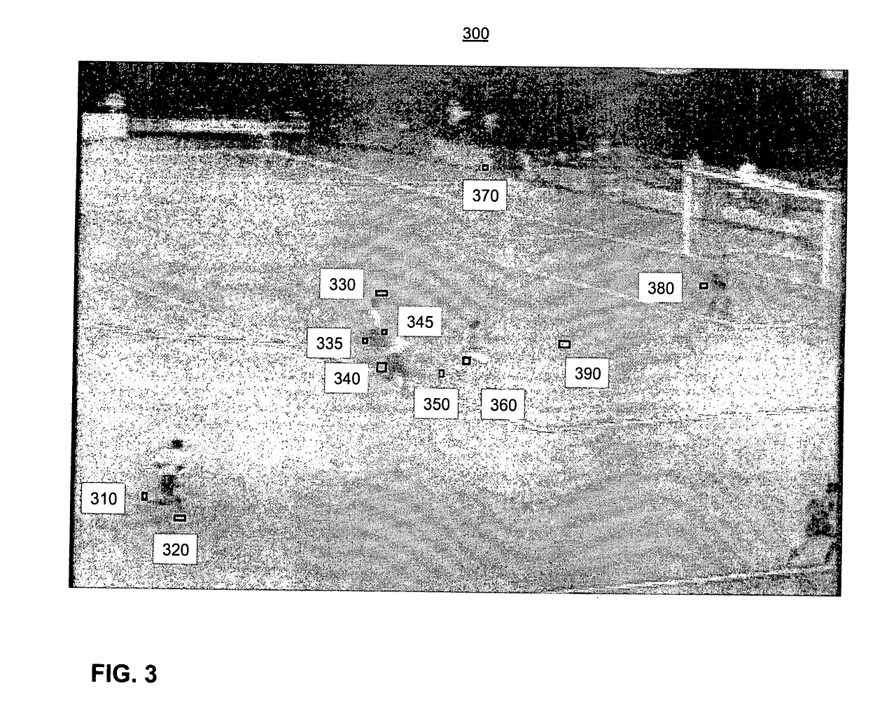

In a preferred embodiment, μ_{A}=7.416, σ_{A}=2.7443, n_{A}=1.3; μ_{E}=1, σ_{E}=1.2355, n_{E}=1.3; μ_{w}=0.14337, σ_{w}=0.034274, n_{w}=1.3; DCCₜₕᵣ=7 pixels, DFₜₕᵣ=10 pixels and NCOMₜₕᵣ=1. The candidate generation process is further described and illustrated below with respect to FIGS. 2 and 3.

At step 150, starting points of trajectories, or “seeds,” are identified. A seed SEEDₖ is a pair of ball candidates {Cᵢ, Cⱼ} in two consecutive frames Fₜ, Fₜ₊₁, where Cᵢ belongs to Fₜ and Cⱼ belongs to Fₜ₊₁, such that the candidates of the pair {Cᵢ, Cⱼ} are spatially closer to each other than a threshold value SEEDₜₕᵣ, and furthermore meet either the criteria that the score of one candidate is three, or that the score of both candidates is two. In a preferred embodiment, SEEDₜₕᵣ=8 pixels. Criteria may be altered to address other concerns, such as time complexity.

At step 160, candidate trajectories are created from the seeds from step 150. A trajectory Tᵢ{C₁ⁱ, C₂ⁱ, . . . , Cⁱ_{N}} is defined as a set of candidates in contiguous frames, one per frame, which form a viable hypothesis of a smoothly moving object in a certain time interval or frame range generated using the seed SEEDᵢ.

A linear Kalman filter is used to create the trajectories by growing the seed in both directions. The two samples that compose the seed determine the initial state for the filter. Using this information, the filter predicts the position of the ball candidate in the next frame. If there is a candidate in the next frame inside a search window centered at the predicted position, the candidate nearest to the predicted position is added to the trajectory and its position is used to update the filter. If no candidate is found in the window, the predicted position is added to the trajectory as an unsupported point and is used to update the filter.

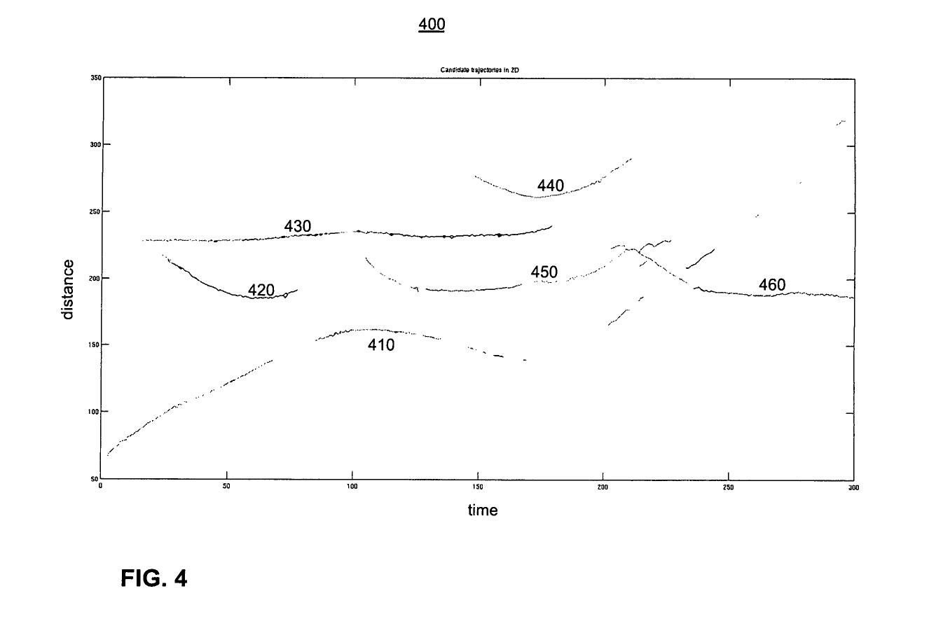

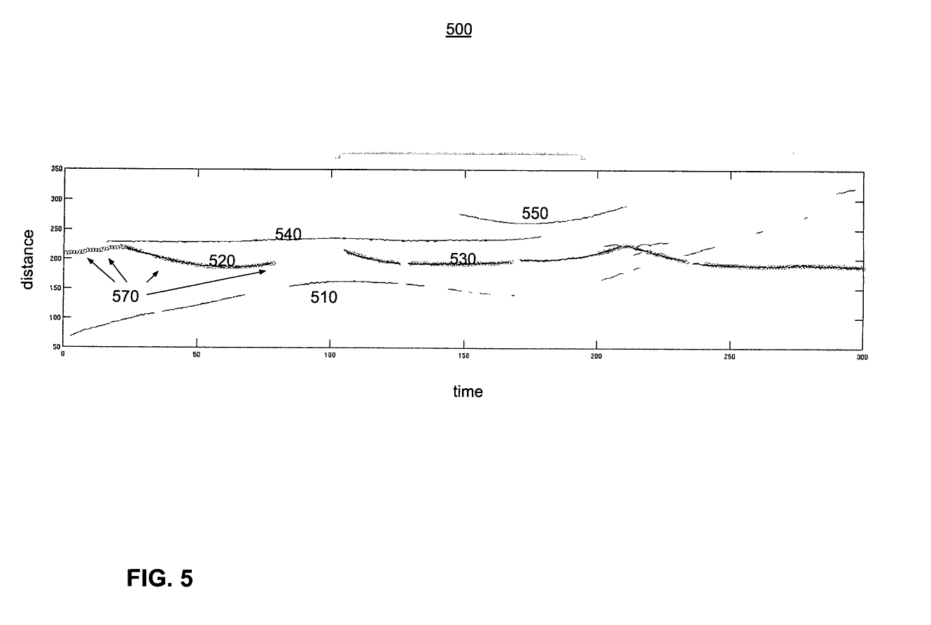

In a preferred embodiment, a trajectory building procedure is terminated if a) there are no candidates near the predicted positions for N consecutive frames, and b) there are more than K candidates near the predicted position (e.g., K=1). The filter works in a bidirectional manner, so after growing the trajectory forward in time, the Kalman filter is re-initialized and grown backward in time. The first criterion to terminate a trajectory produces a set of unsupported points at its extremes. These unsupported points are then eliminated from the trajectory. The trajectory generation and selection process is further described an illustrated below with respect to FIGS. 4 and 5.

Some of the candidate trajectories T={T₁, T₂, . . . , T_{M}} may be parts of the path described by the actual ball, while others are trajectories related to other objects. The goal of the algorithm is to create a trajectory BT by selecting a subset of trajectories likely to represent the path of the actual ball, while rejecting the others. The algorithm comprises the use of a trajectory confidence index, a trajectory overlap index, and a trajectory distance index. A score for each trajectory is generated based on the length of the trajectory, the scores of the candidates that compose the trajectory, and the number of unsupported points in the trajectory.

A confidence index Ω(Tᵢ) is computed for the trajectory Tⱼ as:

Ω(Tⱼ)=Σᵢ₌₁³λᵢpᵢ+Σᵢ₌₂³ωᵢqᵢ=τr

where:
pᵢ is the number of candidates in Tⱼ with score “i”,
qᵢ=pᵢ/|Tⱼ|, where |Tⱼ| is the number of candidates in the trajectory, denotes the fractions of candidates with score “i” in the trajectory,
λᵢ and ωᵢ (λ₁<λ₂<λ₃ and ω₂<ω₃) adjust the importance of the components,
r is the number of unsupported points in the trajectory, and
τ is the importance factor for the unsupported points.

In a preferred embodiment λ₁=0.002, λ₂=0.2, λ₃=5, ω₂=0.8, ω₃=2, and τ=10.

For each selected trajectory, there may be others that overlap in time. If the overlap index is high, the corresponding trajectory will be discarded. If the index is low, the overlapping part of the competing trajectory will be trimmed.

The overlap index penalizes the number of overlapping frames while rewarding long trajectories with a high confidence index, and is computed as:

$$χ ( {T}_{i} , {T}_{j} ) = \frac{ρ ( {T}_{i} , {T}_{j} )}{\vert {T}_{i} \vert \times Ω ( {T}_{i} )}$$

where:
χ(Tᵢ,Tⱼ) is the overlapping index for the trajectory Tᵢ with the trajectory Tⱼ,
ρ(Tᵢ,Tⱼ) is the number of frames in which Tᵢ and Tⱼ overlap, and
Ω(Tᵢ) is the confidence index for the trajectory Tᵢ.

The use of the trajectory distance index increases the spatial-temporal consistency of BT. Using the assumption that the ball moves at a maximum velocity Vₘₐₓ pixels/frame, two trajectories BT and Tᵢ are incompatible if the spatial distance of the ball candidates between the closest extremes of the trajectories is higher than Vₘₐₓ times the number of frames between the extremes plus a tolerance D. Otherwise, they are compatible and Tᵢ can be part of BT.

The distance index is given by:

$$DI ( BT , {T}_{i} ) = \{ \begin{matrix}1 & if CPD ( BT , {C}_{1}^{i} ) < ( frame ( {C}_{1}^{i} ) - CPF ( BT , {C}_{1}^{i} ) ) \times {V}_{max} + D and \\ & CND ( BT , {C}_{N}^{i} ) < ( CNF ( BT , {C}_{N}^{i} ) - frame ( {C}_{N}^{i} ) ) \times {V}_{max} + D \\ 0 & otherwise\end{matrix} \\ \text{where:} \\ CPD ( BT , {C}_{j} ) = \{ \begin{matrix}dist ( pos ( {BT}_{i} ) , pos ( {C}_{j} ) ) \vert frame ( {BT}_{i} ) = CPF ( BT , {C}_{j} ) if CPF ( BT , {C}_{j} ) \neq - 1 \\ - 1 otherwise\end{matrix} \\ CND ( BT , {C}_{j} ) = \{ \begin{matrix}dist ( pos ( {BT}_{i} ) , pos ( {C}_{j} ) ) \vert frame ( {BT}_{i} ) = CNF ( BT , {C}_{j} ) if CNF ( BT , {C}_{j} ) \neq - 1 \\ - 1 otherwise\end{matrix} \\ CPF ( BT , {C}_{j} ) = \{ \begin{matrix}max ( i ) \vert frame ( {BT}_{i} ) < frame ( {C}_{j} ) \\ - 1 otherwise\end{matrix} \\ CNF ( BT , {C}_{j} ) = \{ \begin{matrix}min ( i ) \vert frame ( {BT}_{i} ) > frame ( {C}_{j} ) \\ - 1 otherwise\end{matrix} \\ {T}_{i} = \{ {C}_{1}^{i} , {C}_{2}^{i} , … , {C}_{N}^{i} \}$$

and where:
dist(pos(Cᵢ), pos(Cⱼ)) is the Euclidean distance between the position of the candidates Cᵢ and Cⱼ,
frame(Cᵢ) is the frame to which the candidate Cᵢ belongs,
pos(C) is the (x,y) position of the center of the candidate C inside the frame,
BTᵢ is the i-th candidate in BT,
CPD stands for Closest Previous Distance,
CND stands for Closest Next Distance,
CPF stands for Closest Previous Frame, and
CNF stands for Closest Next Frame.

If DI(BT, Tᵢ)=1, then the trajectory Tᵢ is consistent with BT. Without this criterion, adding Tᵢ to BT can present the problem of temporal inconsistency, where the ball may jump from one spatial location to another in an impossibly small time interval. By adding the distance index criterion in the trajectory selection algorithm, this problem is solved. In a preferred embodiment, Vₘₐₓ=10 pixels/frame and D=10 pixels.

Given T, the set of candidate trajectories, the algorithm produces as output BT, a subset of candidate trajectories that describe the trajectory of the ball along the video sequence. The algorithm iteratively takes the trajectory from T with the highest confidence index and moves it to BT. Then, all the trajectories in T overlapping with BT are processed, trimming or deleting them depending on the overlapping index χ(BT, Tᵢ) and the distance index DI(BT,Tᵢ). The algorithm stops when there are no more trajectories in T.

The algorithm can be described as follows:

BT = empty set
while (T not empty) do

H = trajectory with highest confidence index from T
Add H to BT
Remove H from T
for i = 1 to length(T) do

if (χ(BT ,Tᵢ) < Oₜₕᵣ) then

trim(BT, Tᵢ)

else

Remove Tᵢ from T

for i = 1 to length(T) do

if (DI(BT, Tᵢ) = 0) then

Remove Tᵢ from T

The trim operation trim(BT, Tᵢ) consists of removing from the trajectory Tᵢ all candidates lying in the overlapping frames between BT and T. If this process leads to temporal fragmentation of Tᵢ (i.e., candidates are removed from the middle), the fragments are added as new trajectories to T and Tᵢ is removed from T. In a preferred embodiment, the overlap index threshold Oₜₕᵣ=0.5 is used.

With the ball trajectory selected, frames may be processed so as to enhance the appearance of the ball. For instance, a highlight color may be placed over the location or path of the ball to allow the viewer to more easily identify its location. The trajectory may also be used at the encoding stage to control local or global compression ratios to preserve sufficient image quality for the ball to be viewable.

The results of various steps of method 100 are illustrated in FIGS. 2 through 5. These figures represent the application of a particular embodiment of the invention to particular example video data and should not be construed as limiting the scope of the invention.

FIG. 2 provides graphical illustrations 200 of the processes of playfield and candidate detection of steps 120 and 130. Given an input frame 210, the soccer field pixels are identified using the knowledge that the field is made of grass or grass-colored material. The result of the process is a binary mask 220 classifying all field pixels as 1 and all non-field pixels, including objects in the field, as 0. Objects on the field, such as players, lines, and the ball, appear as holes in the mask since they are not the expected color of the field. The result of the candidate detection step 130 is shown in image 230. Each white object in the image represents a connected set of pixels identified as local luminance maxima. The result of the determination of the boundaries of the soccer field from step 120 is shown in 240. The holes in the mask from players, lines, and the ball are removed during the field detection process, creating a large contiguous field mask. Candidates in image 230 not within the field area of image 240 are eliminated, resulting in image 250.

FIG. 3 illustrates the result of identification of ball candidates in a frame 300 at step 140. Bounding boxes indicate the locations of ball candidates after the sieving and qualification process. In this illustration, candidates 310, 320, 335, 340, 360, and 380 represents parts of players or their attire, candidates 330 and 370 represent other objects on the field, and 390 represents the actual ball.

FIG. 4 is a plot 400 of candidate trajectories 410-460 created at step 160. The x-axis represents the time in frames. The y-axis is the Euclidean distance between the potential ball and the top left pixel of the image. A single real-world trajectory may appear as multiple trajectory segments. This can be the result of the object following the trajectory becoming obscured in some frames, or changes in camera or camera angle, for instance.

FIG. 5 is a plot 500 of a set of candidate trajectories 510-550 with a particular trajectory selected as being that of the ball at step 170. The x-axis represents the time in frames. The y-axis is the Euclidean distance between the ball and the top left pixel of the image. Trajectories 520 and 530 are selected by the algorithm to describe the trajectory of the ball. Trajectories 510, 540, and 550 are rejected by the algorithm. The ellipses 570 represent the actual path of the ball in the example video. For this example, it can be seen that the trajectory selection algorithm provided a highly accurate estimate of the real ball trajectory.

An alternative method to create the final ball trajectory is based on Dijkstra's shortest path algorithm. The candidate trajectories are seen as nodes in a graph. The edge between two nodes (or trajectories) is weighted by a measure of compatibility between the two trajectories. The reciprocal of the compatibility measure can be seen as the distance between the nodes. If the start and end trajectories (Tₛ, Tₑ) of the entire ball path are known, the trajectories in between can be selected using Dijkstra's algorithm which finds the shortest path in the graph between nodes Tₛ and Tₑ by minimizing the sum of distances along the path.

As a first step, a compatibility matrix containing the compatibility scores between trajectories is generated. The cell (i, j) of the N×N compatibility matrix contains the compatibility score between the trajectories Tᵢ and Tⱼ, where N is number of candidate trajectories.

If two trajectories Tᵢ and Tⱼ overlap by more than a certain threshold, or Tᵢ ends after Tⱼ, the compatibility index between them will be infinite. By enforcing a rule that Tᵢ ends after Tⱼ, we ensure that the path always goes forward in time. Note that this criterion means that the compatibility matrix is not symmetric, as φ(Tᵢ, Tⱼ) need not be the same as φ(Tᵢ, Tⱼ). If the overlapping index between Tᵢ and Tⱼ is small, the trajectory with lower confidence index will be trimmed for purposes of computing the compatibility index.

The compatibility index between the two trajectories is defined as:

$$Φ ( {T}_{i} , {T}_{j} ) = \frac{1}{\begin{matrix}\begin{matrix}( 1 - {e}^{α \times ( Ω ( {T}_{i} ) + Ω ( {T}_{j} ) )} ) \\ ( {e}^{β \times max ( 0 , sdist ( {T}_{i} , {T}_{j} ) - {V}_{max} \times tdist ( {T}_{1} , {T}_{j} ) )} )\end{matrix} \\ ( {e}^{γ \times ( tdist ( {T}_{i} , {T}_{j} ) - 1 )} )\end{matrix}}$$

where:
φ(Tᵢ, Tⱼ) is the compatibility index between the trajectories Tᵢ and Tⱼ,
Ω(Tᵢ) is the confidence index of the trajectory Tᵢ,
sdist(Tᵢ, Tⱼ) is the spatial distance in pixels between the candidates at the end of Tᵢ and at the beginning of Tⱼ,
tdist(Tᵢ, Tⱼ) is the time in frames between the end of Tᵢ and the beginning of Tⱼ, and
α, β and γ (all <0) are the relative importance of the components.

In a preferred embodiment, α=−1/70, β=−0.1 and γ=−0.1.

Once the compatibility matrix is created, Dijkstra's shortest path algorithm can be used to minimize the distance (i.e., the reciprocal of compatibility) to travel from one trajectory node to another.

If the start and end trajectories (Tₛ, Tₑ) of the entire ball path are known, the intermediate trajectories can be found using the shortest path algorithm. However, Tₛ and Tₑ are not known a priori. In order to reduce the complexity of checking all combinations of start and end trajectories, only a subset of all combinations is considered, using trajectories with a confidence index higher than a threshold. Each combination of start and end trajectories (nodes) is considered in turn and the shortest path is computed as described earlier. Finally, the overall best path among all these combinations is selected.

The best ball trajectory will have a low cost and be temporally long, minimizing the function:

SC(Q)=w×(CD(Q)/max_{—}c)+(1−w)×((1−length(Q))/max_{—}l)

where:
Q is a subset of trajectories from T (ball path) constructed using the shortest path algorithm from an initial trajectory Tᵢ to a final trajectory Tⱼ,
SC(Q) is a score for Q,
CD(Q) is the cost for going from the initial trajectory Tᵢ to the final trajectory Tⱼ passing through the trajectories in Q,
length(Q) is the length of the trajectory set Q in time (i.e. number of frames covered by Q including the gaps between trajectories),
max_c and max_l are the maximum cost and maximum length among all shortest paths constructed (one for each combination of start and end trajectories), and
w is the relative importance of cost vs. length.

In a preferred embodiment, w=0.5.

While the present invention has been described in terms of a specific embodiment, it will be appreciated that modifications may be made which will fall within the scope of the invention. For example, various processing steps may be implemented separately or combined, and may be implemented in general purpose or dedicated data processing hardware or in software, and thresholds and other parameters may be adjusted to suit varying types of video input.

1. A method of detecting and enhancing a moving object in a video sequence comprising the steps of:
identifying sets of connected components in a video frame;
evaluating each of said sets of connected components with regard to a plurality of image features;
comparing said plurality of image features of each of said sets of connected components to predetermined criteria to produce a filtered list of connected components;
repeating said identifying, evaluating, and comparing steps for contiguous frames;
identifying candidate trajectories of connected components across multiple frames;
evaluating said candidate trajectories to determine a selected trajectory; and
processing images in said video sequence based at least in part upon said selected trajectory.

2. The method of claim 1 wherein said plurality of image features comprises area, eccentricity, or whiteness.

3. The method of claim 1 wherein said step of identifying sets of connected components comprises processing an image of said video sequence to create an image representing local maxima.

4. The method of claim 3 wherein said step of processing an image of said video sequence to create a binary image representing local maxima comprises convolving the luminance component of the image with a kernel.

5. The method of claim 4 wherein the kernel is a normalized Gaussian kernel.

6. The method of claim 1 wherein said image representing local maxima is a binary image.

7. The method of claim 1 wherein said criteria comprises distance to the closest candidate, distance to the edge of the field, or the number of candidates inside the same connected component in the object mask.

8. The method of claim 1 wherein said step of evaluating said candidate trajectories to determine a selected trajectory comprises: identifying pairs of connected components, wherein one component of the pair is in the first image and one component of the pair is in the subsequent image, and wherein the distance between the locations of the two connected components in the pair is below a predetermined distance threshold.

9. The method of claim 1 wherein said step of evaluating said candidate trajectories to determine a selected trajectory comprises: evaluating the length of the trajectory, the characteristics of the connected components that compose the trajectory, and the number of unsupported points in the trajectory.

10. The method of claim 1 wherein said step of processing images in said video sequence based at least in part upon said selected trajectory comprises highlighting the object moving along the selected trajectory.

11. An apparatus for detecting and enhancing a moving object in a video sequence comprising the steps of:
means for identifying sets of connected components in a video frame;
means for evaluating each of said sets of connected components with regard to a plurality of image features;
means for comparing said plurality of image features of each of said sets of connected components to predetermined criteria to produce a filtered list of connected components;
means for repeating said identifying, evaluating, and comparing steps for contiguous frames;
means for identifying candidate trajectories of connected components across multiple frames;
means for evaluating said candidate trajectories to determine a selected trajectory; and
means for processing images in said video sequence based at least in part upon said selected trajectory.

12. The apparatus of claim 11 wherein said plurality of image features comprises area, eccentricity, or whiteness.

13. The apparatus of claim 11 wherein evaluating said candidate trajectories to determine a selected trajectory comprises: identifying pairs of connected components, wherein one component of the pair is in the first image and one component of the pair is in the subsequent image, and wherein the distance between the locations of the two connected components in the pair is below a predetermined distance threshold.

14. The apparatus of claim 11 wherein evaluating said candidate trajectories to determine a selected trajectory comprises: evaluating the length of the trajectory, the characteristics of the connected components that compose the trajectory, and the number of unsupported points in the trajectory.

15. The apparatus of claim 11 wherein processing images in said video sequence based at least in part upon said selected trajectory comprises highlighting the object moving along the selected trajectory.

16. An apparatus detecting and enhancing a moving object in a video sequence comprising the steps of:
a processor for:
identifying sets of connected components in a video frame;
evaluating each of said sets of connected components with regard to a plurality of image features;
comparing said plurality of image features of each of said sets of connected components to predetermined criteria to produce a filtered list of connected components;
repeating said identifying, evaluating, and comparing steps for contiguous frames;
identifying candidate trajectories of connected components across multiple frames;
evaluating said candidate trajectories to determine a selected trajectory; and
processing images in said video sequence based at least in part upon said selected trajectory.

17. The apparatus of claim 16 wherein said plurality of image features comprises area, eccentricity, or whiteness.

18. The apparatus of claim 16 wherein evaluating said candidate trajectories to determine a selected trajectory comprises: identifying pairs of connected components, wherein one component of the pair is in the first image and one component of the pair is in the subsequent image, and wherein the distance between the locations of the two connected components in the pair is below a predetermined distance threshold.

19. The apparatus of claim 16 wherein evaluating said candidate trajectories to determine a selected trajectory comprises: evaluating the length of the trajectory, the characteristics of the connected components that compose the trajectory, and the number of unsupported points in the trajectory.

20. The apparatus of claim 16 wherein processing images in said video sequence based at least in part upon said selected trajectory comprises highlighting the object moving along the selected trajectory.
